(19) United States
(12) Patent Application Publication
(10) Pub. No.: US 2009/0313177 A1
(43) Pub. Date: Dec. 17, 2009

(54) SYSTEM FOR DETERMINING AND BALANCING ACTUAL ASSET ALLOCATION

(76) Inventor: Wesley W. Whitmyer,, JR., Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/403,826

(22) Filed: Mar. 13, 2009

(51) Int. Cl. G06Q 40/00

(52) U.S. Cl. 705/36 R

(57) ABSTRACT

A system for determining and balancing actual asset allocation including a server, software executing on the server for receiving asset data pertaining to amounts of each of a plurality of assets owned by a client, wherein a portion of the assets are divisible assets, software for receiving a desired asset allocation from the client, software for parsing the asset data into amounts of two or more component assets, a database of component assets, each of the component assets assigned an asset type, software executing for returning from the database an asset type for each of the two or more component assets, software for calculating at least a partial actual asset allocation from the amounts and types of the two or more component assets, and software for comparing the actual asset allocation to the desired asset allocation and reporting to the client.

### FIELD OF THE INVENTION

The invention relates to personal finance management, and more specifically to a system and method for determining and balancing actual asset allocation.

### BACKGROUND OF THE INVENTION

Various systems and tools for managing financial assets are available. Some brokerage firms provide clients with Internet access to their accounts with the ability to view current assets, to buy and sell assets, and, in some cases, to view the allocation of the client's assets within the client's portfolio. For example, some tools may indicate an approximate allocation by asset class and further suggest appropriate allocations for diversification.

Existing systems and tools generally provide assistance for managing a signal account or a single portfolio. However, these tools are limited to the particular account and do not consider other accounts or assets of the client. Thus, problems arise when a client has multiple portfolios and accounts managed by different brokerage firms and/or in different locations. The client may be able to determine an approximate allocation of assets in each particular account, but it is inconvenient if not impossible to determine the client's overall allocation of all assets.

The problem is further complicated when the client owns divisible assets, such as funds, that include multiple assets. For example, a mutual fund may include any number of securities and even other funds. Often funds are designed with an asset category or class, but the allocation of particular securities within the fund may change or “drift” on a regular basis such that the asset category or class of the fund may not always be accurate. Thus, it is difficult for the client to even determine what securities and types of securities he/she owns at any given time.

Finally, even if a person were to determine an actual allocation of their assets, it is difficult to determine the best way to rebalance the allocation among multiple assets held in multiple accounts, some of which may be tax-advantaged such as 401(k) and IRA accounts as opposed to ordinary brokerage accounts.

What is desired therefore is a system and method for determining and balancing actual allocation of assets.

### SUMMARY OF THE INVENTION

Accordingly, it is an object of the present invention to provide a system and method for determining the actual allocation of all of a person's assets, regardless of the location or broker management of the assets. It is a further object of the present invention to provide such a system that determines the actual allocation of assets considering all assets including but not limited to securities, cash, and property. It is a further object of the present invention to provide such a system that determines and recommends how best to rebalance actual allocation.

These and other objects are achieved, and the problem of not being able to determine and balance a person's actual asset allocations is solved, by providing a system and method with software for determining all of a person's assets, software for calculating the actual allocation of all of the person's assets including securities within divisible assets, software for comparing the actual allocation to a preferred or desired allocation, and software for determining the best approach for rebalancing the actual allocation based on the client's assets and account types and trade terms.

In one exemplary embodiment, a system for determining and balancing actual asset allocation is provided including a server, software executing on the server for receiving asset data pertaining to amounts of each of a plurality of assets owned by a client, wherein a portion of the assets are divisible assets, software for receiving a desired asset allocation from the client, software for parsing the asset data into amounts of two or more component assets, a database of component assets, each of the component assets assigned an asset type, software executing for returning from the database an asset type for each of the two or more component assets, software for calculating at least a partial actual asset allocation from the amounts and types of the two or more component assets, and software for comparing the actual asset allocation to the desired asset allocation and reporting to the client.

In some embodiments, the system further includes software executing on the server for identifying at least one of the asset types, and at least one of the divisible assets including component assets assigned the at least one asset type, to trade if the actual allocation and the desired allocation do not match. In some embodiments, the system also includes software for identifying each account held by the client comprising one or more of the assets. The system may also include software for receiving account type data pertaining to each of the accounts comprising the plurality of assets and suggesting at least one of the accounts in which to effect a trade to balance the actual asset allocation.

In some embodiments, the system includes software for determining and displaying to the client a total value of the plurality assets, a change in the total value over a particular time period, and/or an actual return on investments.

Other objects are achieved by providing a system for determining and balancing actual asset allocation including an asset identification module on a server receiving, from a client via a network, asset data pertaining to amounts of a plurality of assets and parsing the asset data to indentify amounts of two or more component assets included in the plurality of assets, a desired asset allocation received from the client via the network, an allocation module calculating at least a partial actual asset allocation of the component assets from the amounts and asset types of the component assets and comparing the actual asset allocation to the desired asset allocation to identify an imbalance, and an allocation rebalance module for determining at least one of the plurality of assets to trade to balance the allocation.

Other objects of the present invention are achieved by providing a method for determining and balancing actual asset allocation, including the steps of receiving asset data pertaining to a plurality of assets owned by a client, wherein at least a portion of the assets are divisible assets, receiving a desired asset allocation from the client, parsing the asset data until each of a plurality of component assets included in the plurality of assets is identified, assigning an asset type to each component asset, calculating an actual asset allocation of the component assets among two or more asset types, and comparing the actual allocation to the desired asset allocation to determine a match.

Other objects of the invention and its particular features and advantages will become more apparent from consideration of the following drawings and accompanying detailed description.

### BRIEF DESCRIPTION OF THE DRAWINGS

FIGS. 1A-1B illustrate a system according to an exemplary embodiment of the present invention.

FIG. 2 illustrates a method according to an exemplary embodiment of the present invention.

FIGS. 3A-3D illustrate displays generated by the system shown in FIGS. 1A-1B.

FIGS. 4A-4D illustrate displays generated by the system shown in FIGS. 1A-1B.

FIGS. 5A-5B illustrate displays generated by the system shown in FIGS. 1A-1B.

### DETAILED DESCRIPTION OF THE INVENTION

The system and method according to the present invention provides means to determine and balance actual asset allocation. Asset allocation refers to how investments are distributed among various types or classes of assets or investments. Asset types may broadly include cash, bonds, stocks, real estate, foreign currency, natural resources, precious metals, and/or luxury collectables. Equity assets may be further defined or broken down by size (e.g., Large-Cap, Mid-Cap, Small-Cap) or by style (e.g., growth, blend, value), and may further include real estate investment trusts (“REIT”), international investments, and/or life settlements. Asset types also include sectors and subsectors within industries or otherwise.

The system and method according to present invention determines an actual asset allocation for clients by considering all of a client's assets and asset types and by determining the component assets included in any divisible assets at a given time. The system and method can then determine and recommend trades based on the actual asset allocation versus a desired asset allocation and based on the types of accounts owned or controlled by the client and any fees or tax implications associated with such accounts.

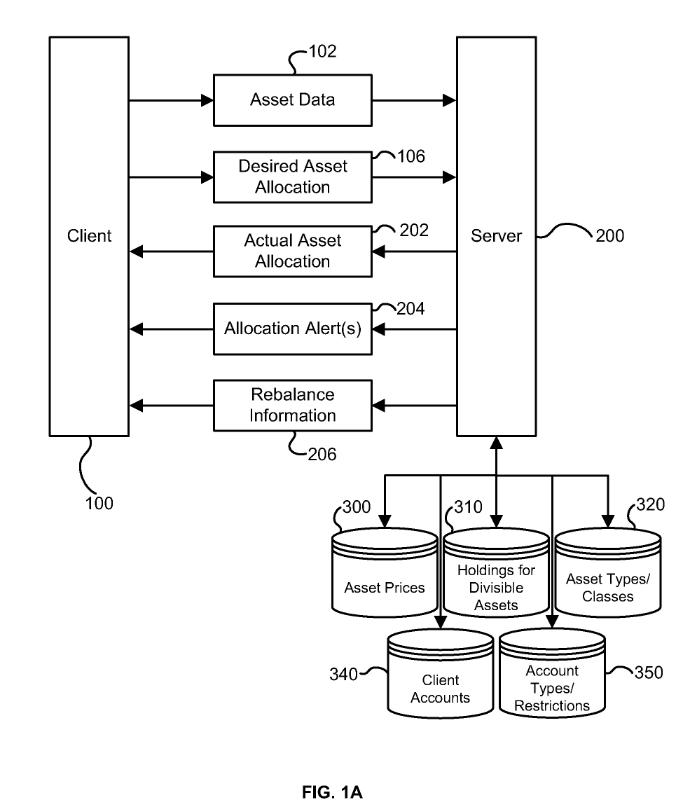

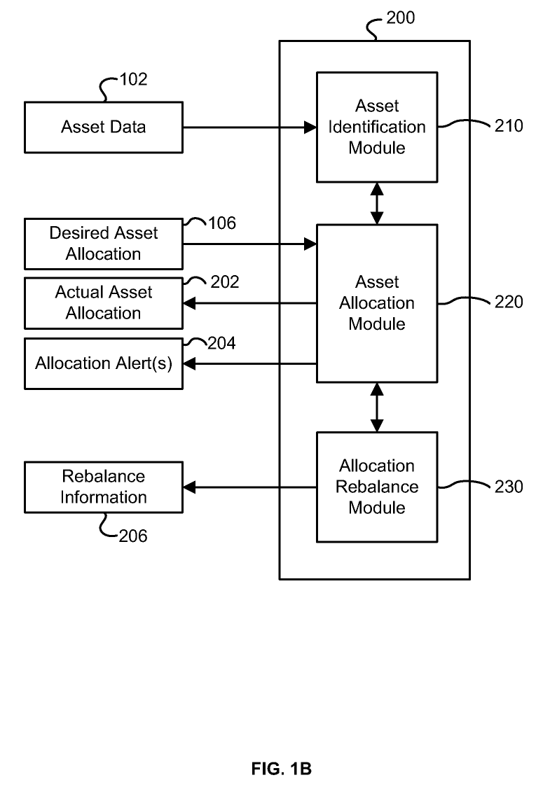

FIGS. 1A-1B show a system according to an exemplary embodiment of the present invention. The system includes a server 200 or central computer accessible by a plurality of clients 100 via a communications network, such as the Internet. The system also includes any number of databases accessible by the server 200. The databases may include, for example, asset type data, asset prices, holdings within divisible assets, and asset trading terms (e.g., restrictions, costs). For example, the system may include one or more asset price databases 300, holdings for divisible assets databases 310, and asset type/class databases 320. In some embodiments, the databases include prospectuses for particular assets and other publically available reports and information about assets. The databases are updated continuously and/or periodically as new information becomes available.

The system also includes one or more databases 340/350 including account data. Account data may include account type data, account trading restrictions/costs, and account tax data. For example, the account data may include data identifying a certain account as a 401(k) account and include data indicative of the costs associated with trading in the particular 401(k) account (e.g., brokerage fees, etc.) and data indicative of the tax implications of trading in the account. The account data is updated, continuously and/or periodically, for changes from the broker of the account and changes in tax laws and regulations.

Shown in FIG. 1B, the system includes software 210 executing on the server 200 for identifying each of a plurality of assets owned or held by the client 100, and the amounts thereof (e.g., numbers of shares, value, etc). The software 210 receives asset data 102 from the client 100 and/or the databases. The asset data 102 may include the identification and amounts of at least some of the client's assets and accounts (e.g., by account number, etc). The asset data 102 may also include asset purchase information including the purchase price of each client asset and/or a number of shares purchased. In some embodiments, the system determines the client's assets and asset purchase information by accessing and/or logging into accounts held by the client 100. For example, the asset data 102 may include account numbers and/or log-in information from which the system will access the accounts to identify the client's assets. The client 100 also provides a desired or target asset allocation 106. For example, the client 100 may provide a desired allocation including a desired percentage for each of a number of assets or asset types.

Some of the client's assets may be indivisible, such as some individual securities, cash, and/or certain real estate assets. At least a portion of the client's assets owned by the client 100 are divisible assets comprised of two or more assets. A divisible asset includes component assets which may be other divisible assets or indivisible assets. For example, a divisible asset may be a fund, such as a mutual fund. The system receives the asset data 102 and parses the asset data 102 to identify all of the component assets owned by the client, either owned directly (e.g., client's holdings) or within a divisible asset or fund (e.g., client's subholdings). In some embodiments, when divisible assets include other divisible assets, the system's parsing software (e.g., 210) will continue to parse the asset data until only the indivisible assets which make up the client's assets remain.

The system includes software 220 executing on the server 200 for calculating an actual asset allocation 202 of the client's assets. The allocation 202 calculated by the system includes an actual asset allocation considering each of the assets and any and all component assets which make up the assets. Each component asset may be assigned a particular asset type and an actual allocation of assets by type is calculated. The allocation 202 may be provided with any desired level of detail, such as a high-level allocation among asset types such as cash, bonds, stocks, real estate, foreign currency, natural resources, precious metals, and/or luxury collectables. Allocation among equity assets may be further determined and provided by size (e.g., Large-Cap, Mid-Cap, Small-Cap), by style (e.g., growth, blend, value), real estate investment trusts (“REIT”), international investments, and/or life settlements. Allocations may further be identified by sectors and subsectors.

The software 220 compares the asset allocation 202 of client's assets to the client's desired asset allocation 106. The desired asset allocation 106 may include any level of detail desired by the client. The system may then report or alert the client of the results of the comparison to the client. If the actual allocation 202 does not match the desired allocation 106, software 220 of the system alerts 204 the client 100 (e.g., by email or display).

The system, via an allocation rebalance module 230, may recommend trades to correct and/or mitigate the imbalance. Recommended trades, or rebalancing information 206, may include one or more assets or asset types to trade, and the particular account to trade in. For the example, the system can identify one or more asset types to trade and provide a list of potential assets which include the identified asset types. The system may suggest that the client buy or sell a particular asset type and propose a list of certain divisible, component and/or indivisible assets already owned by the client to buy more of or sell. In some instances, the system proposes a list of new divisible, component, and/or indivisible assets to purchase. When the client does not directly own any component and/or indivisible assets of the asset type to trade, the system proposes a trade of one or more divisible assets owned by the client having the greatest amount of the asset type.

The system includes software (e.g., 210) executing on the server 200 for receiving account type data and determining the type and properties of each of the client's plurality of accounts. For example, the client's accounts include retirement or 401k accounts, IRA's, 529 accounts, bank accounts, brokerage accounts, and/or private investment accounts (e.g., hedge funds). Each account or account type may have different rules for trading, management fees, tax consequences (e.g., tax rate, fees), etc. Each particular account may also have different fees associated with executing a trade which are determined and analyzed by the system. Based on this information, the software 230 determines the best account in which to effect the recommended trade(s). Therefore, the rebalance information 206 may include a display with the list of recommended assets to trade, a recommended trade type (e.g., buy, sell), and recommended account(s) in which to trade for review and selection by the client.

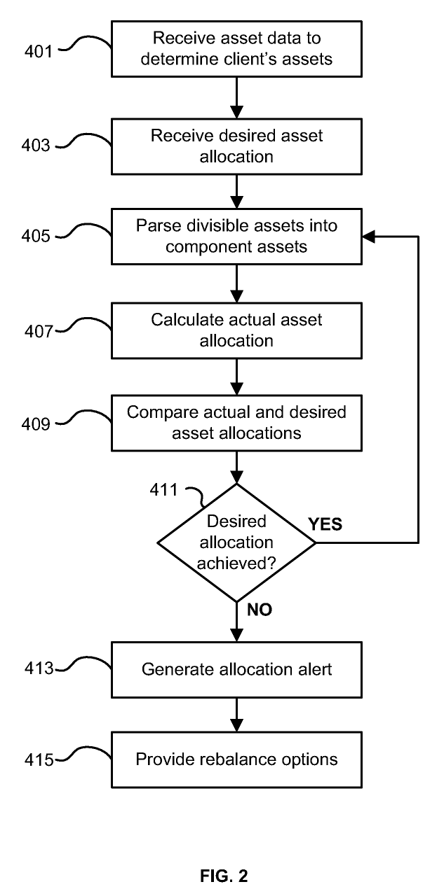

FIG. 2 shows a method according to an exemplary embodiment of the present invention. The method includes receiving asset data 102 to determine a client's assets, wherein at least one of the client's assets is a divisible asset (step 401). For example, the client's assets may include one or more divisible assets such as funds and some component and/or indivisible assets, such as individual securities. The divisible assets may include other divisible, component, and/or indivisible assets. In some embodiments, a plurality of accounts held by the client that includes the client's assets are also identified from the asset data. The method also includes receiving a desired asset allocation from the client (step 403). The holdings in one or more divisible assets owned by the client are determined by parsing the divisible assets and/or receiving holdings data pertaining to the divisible assets (step 405). An actual allocation (e.g., by asset type) of all of the client's assets, including the holdings within each particular divisible asset, is then determined is compared to the desired allocation provided by the client (steps 407-409).

If the client's assets are not allocated in accordance with the desired allocation, an allocation alert is generated (steps 411-413). Rebalance options to achieve the desired allocation are determined (step 415). For example, one or more asset types and/or assets to trade to achieve the desired allocation are determined, and at least one of the accounts in which to effect the trade is also determined. The determination of the accounts may be based on the types of the client's accounts, trading terms, and/or the tax consequences or advantages of trading in each of the client's accounts.

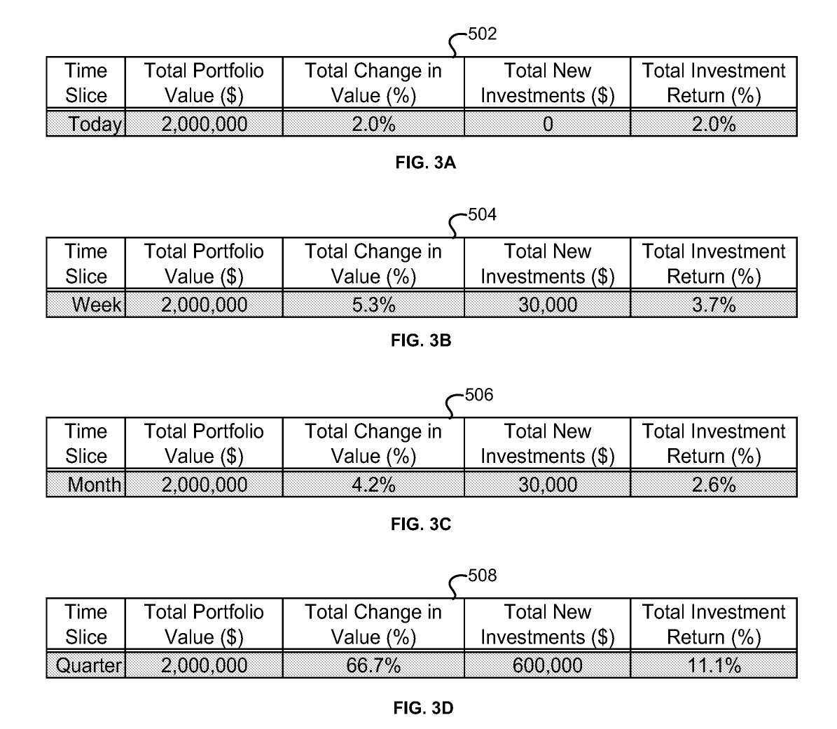

FIGS. 3A-3C illustrate displays generated by the system shown in FIGS. 1A-1B. The system allows the client to view information about the client's assets at different time periods. One or more of the software modules 210-230, and/or a display module, generates the displays accessible by the client 100 (e.g., via the internet). As illustrated, the client 100 may select various time slices to view such as the present day, or the preceding or current week, month, quarter, year, etc. The information available to the client 100 includes a total portfolio value including the total value of all of the client's assets, a total change in portfolio value, a total value of new investments made during the time period, and a total return in investments. The displays 502-508 may be a single dynamic display in which the user can select or scroll through the various time slices.

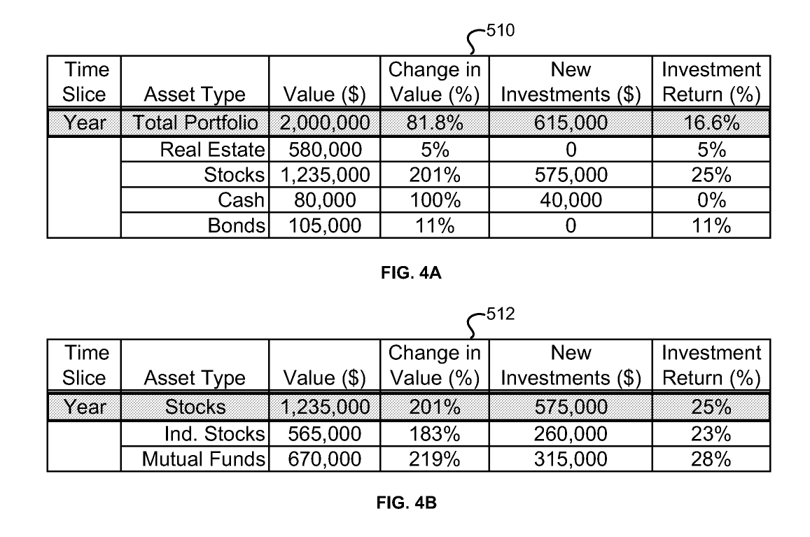

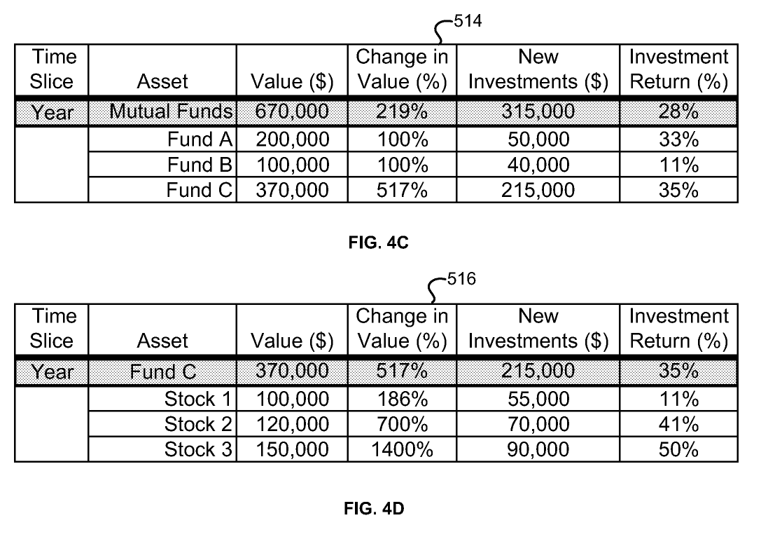

The client 100 may drill down or obtain more information about any one of the displayed parameters. For example, the client 100 may obtain a breakdown of the information by some or all asset types or classes as illustrated in FIG. 4A. In FIG. 4A, the value, change in value, new investments, and investment return is shown for the client's real estate, stocks, cash, and bonds. As shown in FIG. 4B, the client 100 may drill down in the stock assets to obtain a display of the parameters by individual stocks and divisible assets. In the exemplary display, the divisible assets include mutual funds however any type of divisible assets may be displayed and analyzed using the system and method according to the present invention. In the exemplary embodiment, a given mutual fund may include various stocks or, in some cases, other funds. Thus, the client 100 may continue to drill down to obtain detailed information for each of the holdings with a particular fund as shown in FIGS. 4C and 4D.

The information displayed to the client is updated on a regular or periodic basis, or upon request from the client 100. Therefore, the values will change based on the current market value for each asset. Further, the holdings or components within each divisible asset could change as managers of divisible assets (e.g., fund managers) trade assets within the divisible asset.

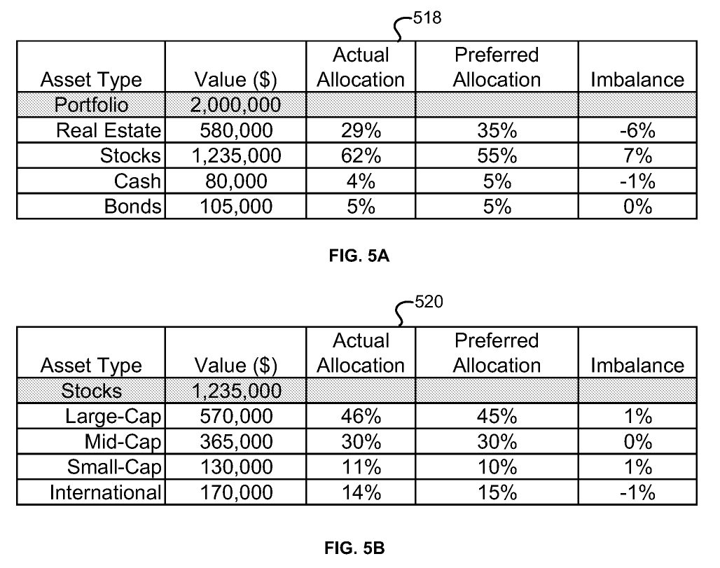

FIGS. 5A-5B illustrate additional displays generated by the system shown in FIGS. 1A-1B. The system may display the client's actual asset allocation as compared to the client's desired asset allocation. The actual and desired allocations can be displayed for the broad asset types, such as real estate, stocks, bonds and cash. The client may also drill down to view and select detailed allocations with each type or class. For example, the client 100 may specify desired allocations and view desired and actual allocations of stock types such as large cap, mid-cap, small-cap, and international stocks as shown in FIG. 5B. In some embodiments, the client 100 may drill down by industry sector, sub-sector, etc.

As shown in FIGS. 5A-5B, the system further displays the imbalance, if any, between the client's desired asset allocation and the actual asset allocation. The client can then drill down to determine what trades to make to correct the imbalance, or accept recommendations from system. The system recommends particular assets to trade to correct and/or mitigate the imbalance, and also the best account in which to effect the trade (e.g., based on account type, fees, and tax implications).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for determining and balancing actual asset allocation, comprising:
a server;
software executing on said server for receiving asset data pertaining to amounts of each of a plurality of assets owned by a client, wherein at least a portion of the assets are divisible assets;
software executing on said server for receiving a desired asset allocation from the client;
software executing on said server for parsing at least a portion of the asset data into amounts of two or more component assets;
a database of component assets, each of the component assets assigned an asset type;
software executing on said server for returning from the database an asset type for each of the two or more component assets;
software executing on said server for calculating at least a partial actual asset allocation from the amounts and types of the two or more component assets; and
software executing on said server for comparing the actual asset allocation to the desired asset allocation and reporting to the client.

2. The system according to claim 1, further comprising:
software executing on said server for identifying at least one of the asset types, and at least one of the divisible assets including component assets assigned the at least one asset type, to trade if the actual allocation and the desired allocation do not match.

3. The system according to claim 1, wherein said software for parsing the asset data receives holdings data from a database accessible to said server to identify component assets comprised in the divisible assets.

4. The system according to claim 1, wherein said software for parsing the asset data parses the asset data two or more times until only indivisible assets comprised in the plurality of assets remain.

5. The system according to claim 1, further comprising:
software executing on said server for identifying one or more accounts held by the client comprising one or more of the plurality of assets.

6. The system according to claim 5, further comprising:
software executing on said server for receiving account type data pertaining to each of the accounts and determining at least one of the accounts in which to effect a trade to balance the actual asset allocation based on the account type data.

7. The system according to claim 6, wherein the account type data includes data identifying each account as at least one of a brokerage account, a managed account, a checking account, a savings account, a certificate of deposit account, and a retirement account.

8. The system according to claim 6, wherein said software for receiving account type data identifies trading terms for each of the accounts, wherein the trading terms include fees and trade restrictions associated with the accounts.

9. The system according to claim 1, wherein the plurality of assets include at least one of stocks, mutual funds, bonds, real estate, and cash.

10. The system according to claim 1, wherein the component assets include individual securities.

11. The system according to claim 1, further comprising:
software for calculating and displaying to the client a total value of the plurality of assets and a change in the total value over a particular time period.

12. The system according to claim 11, wherein said software for calculating and displaying the total value further calculates and displays an actual return on investments over the particular time period.

13. The system according to claim 11, wherein the time period is a one of a preceding week, a preceding month, and a preceding year.

14. A system for determining and balancing actual asset allocation, comprising:
an asset identification module on a server receiving, from a client via a network, asset data pertaining to amounts of a plurality of assets and parsing the asset data to indentify amounts of two or more component assets comprised in the plurality of assets;
a desired asset allocation received from the client via the network;
an allocation module calculating at least a partial actual asset allocation of the component assets from the amounts and asset types of the component assets and comparing the actual asset allocation to said desired asset allocation to identify an imbalance; and
an allocation rebalance module for determining at least one of the plurality of assets to trade to balance the allocation.

15. The system according to claim 14, wherein said allocation rebalance module further determines at least one of the accounts in which to effect the trade.

16. The system according to claim 14, wherein at least one of the plurality of assets is a mutual fund including two or more securities.

17. The system according to claim 14, wherein the component assets include individual securities.

18. The system according to claim 14, further comprising:
wherein at least of the modules calculates a total value of the plurality of assets and a change in the total value over a particular time period.

19. A method for determining and balancing actual asset allocation, comprising the steps of:
receiving asset data pertaining to a plurality of assets owned by a client, wherein at least a portion of the assets are divisible assets;
receiving a desired asset allocation from the client;
parsing the asset data until each of a plurality of component assets comprised in the plurality of assets is identified;
assigning an asset type to each component asset;
calculating an actual asset allocation of the component assets among two or more asset types; and
comparing the actual allocation to the desired asset allocation to determine a match.

20. The method according to claim 19, wherein said step of parsing including parsing the asset data two or more times until only indivisible assets comprised in the plurality of assets remain.

21. The method according to claim 19, further comprising the steps of:
determining at least one of the plurality of assets to trade to achieve the desired asset allocation.

22. The method according to claim 20, further comprising the step of:
determining at least one account in which to effect the trade based on account types.

23. The method according to claim 19, further comprising the step of:
determining and displaying to the client a total value of the plurality of assets and a change in the total value over a particular time period.
